(19) United States
(12) Patent Application Publication
(10) Pub. No.: US 2013/0247782 A1
(43) Pub. Date: Sep. 26, 2013

(54) Waste Compactor, of Simplified Construction and of Small Dimensions, Particularly for Bars, Cafeterias and Other Small Restaurant Businesses

(71) Applicants: Luciano Salda, Marano Sul Panaro (IT); Angelo Cappi, Vignola (IT); Georgi Dimitrov Todorov, Sofia (BG)

(72) Inventors: Luciano Salda, Marano Sul Panaro (IT); Angelo Cappi, Vignola (IT); Georgi Dimitrov Todorov, Sofia (BG)

(73) Assignee: C.M.S. S.p.A., Marano Sul Panaro (IT)

(21) Appl. No.: 13/822,572

(22) PCT Filed: Sep. 8, 2011
(86) PCT No.: PCT/EP2011/065522

§ 371 Date: May 31, 2013

(30) Foreign Application Priority Data
Sep. 15, 2010 (IT) BO2010U000093

(51) Int. Cl. B30B 9/12

(52) U.S. Cl. CPC B30B 9/128
USPC 100/117; 100/131

(57) ABSTRACT

The compactor comprises at least one robust transport screw, helix or spiral (16), which is inclined, of conical shape, downwardly converging, with a downwardly decreasing pitch, and is aligned axially with and fixed to the slow output shaft (117) of a reduction gear unit (17, 217, 317) located above and outside the inclined wall (301) of a loading hopper (1) which has an upper descending portion (101) with at least one hatch (2) for the introduction of the waste to be compacted and a discharge conduit (7) whose outlet opening is shut off by constriction means (8, 108, 208). The lower part (201) of the hopper (1) is shaped in the form of a funnel which is open outwards and is provided with drainage holes (9) and a base area (10) into which any liquid present in the waste tends to flow by gravity, means (13, 14, 114) being provided to collect the liquid and to guide it by gravity towards discharge means (20) a container (18).

The invention relates to a waste compactor, of simplified construction and of small dimensions, which is particularly suitable for positioning under or near the counter of a bar, cafeteria or other small restaurant business, for the purpose of compacting empty plastic bottles, glasses, cups and other small items of used tableware made from plastic material and/or paper, and/or other small solid wastes possibly including liquid residues, with the aim of substantially limiting the volume occupied by these wastes and thus facilitating their disposal by the producers of these wastes and by the parties responsible for collecting them and transporting them to the final recycling and/or disposal centres. The compactor according to the invention is also capable of separating any small liquid component from the solid wastes, thus enabling this liquid component to be collected and disposed of separately from the solid component. The closest prior art to the invention can be identified as the published European patent application EP 2 125 352 (Screw press for compacting solid waste) and the published U.S. Pat. No. 2,397,758 (Pulping machine). The former patent application discloses the use of a first horizontal waste feeding screw limited to a single cylindrical spiral or helix, of limited length, attached at one end to and projecting from support and rotation means, and the use of a screw press which can be located axially in the feed spiral or which can be positioned parallel to and outside the spiral in a separate housing, to receive the wastes which have been fed and initially pressed by the first spiral and to compact them, with the aid of calibrated constriction means which operate at the discharge opening of the press. Drainage means are provided at the base of the stator of the first feed spiral, where any liquid present in the waste tends to accumulate by gravity, for the collection and removal of this liquid. The latter of the aforementioned patents relates to a press having a stator body in the form of a truncated cone with a horizontal axis, in which there is an axially rotatable shaft to which are fixed the ends of a transport spiral which operates at a short distance from the inner longitudinally ribbed surface of the conical body, a plurality of curved blades, suitably offset from each other, being mounted on this shaft. The end of the stator of the device having the greater diameter has an opening in its upper part with a hopper for feeding the product to be pressed, while the lower part of the end of the stator of the device having the smaller diameter has a discharge opening closed by a hatch which can be opened manually. The lower part of the stator of the device is pierced and is surrounded externally by a chamber for collecting liquid which can be discharged by gravity. The product to be pressed is pushed from the wider to the narrower end of the device, by the action of the transport spiral, and is pressed by the force of this spiral, by the progressive decrease in pitch and by the progressive constriction of the cross section of the spiral and of the conical stator in which the spiral rotates, while the product is progressively shredded by the curved blades which have a progressive cutting action with a reduced force on the drive shaft of the device. The liquid produced by the pressing is collected in the drainage circuit lying below and the spent compacted material is discharged through the final discharge opening when it is cyclically opened.

The first of the aforesaid devices cannot be constructed with smaller overall dimensions, since the screw press is positioned horizontally, and therefore the material leaving the discharge opening has to be collected by means extending under and beyond this opening, thus unavoidably increasing the overall dimensions of the device in plan view. The second of the aforesaid devices has a simpler construction than the first, but is subject to the same problem as the first device and cannot provide the required degree of compaction. If this device were positioned with its axis vertical and with the discharge at the bottom, in order to occupy a smaller area in plan view, it would no longer be capable of separating the liquid component from the solid component of the pressed product.

The invention is intended to overcome the limitations of the prior art for the provision of a compacting device for the aforesaid purposes, by means of the solution outlined in the attached claim 1 and in the subsequent dependent claims. The characteristics of the invention, and the advantages derived therefrom, will be made clear by the following description which refers to the figures on the two attached sheets of drawings, in which:

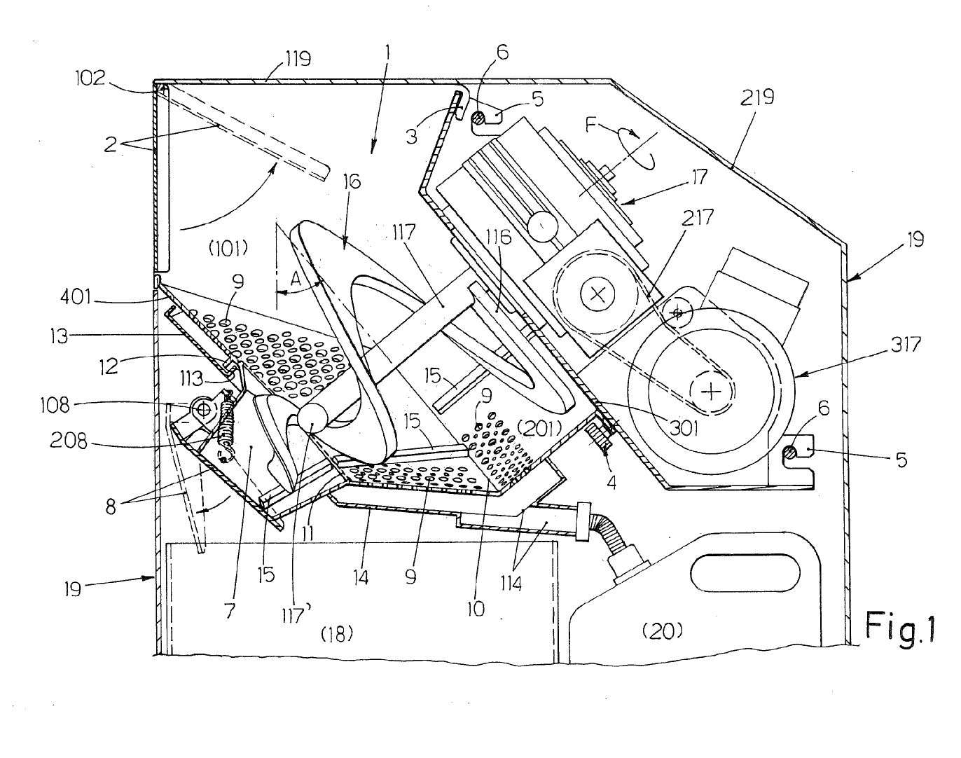

FIG. 1 shows the novel compacting device in side elevation, with parts in section;

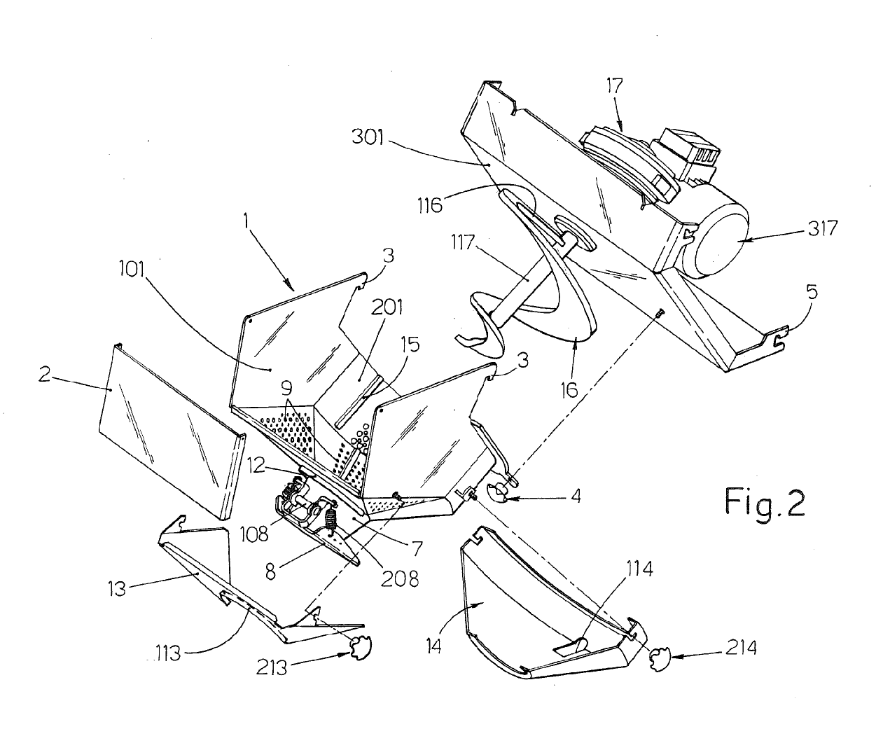

FIG. 2 shows the device of FIG. 1 in perspective and partially broken down into its principal components.

As shown in the drawings, the device comprises a hopper 1 with an upper portion 101 provided, laterally for example, with a hatch 2, for example a hatch oscillating about a horizontal upper axis 102 in such a way that it naturally remains closed by the effect of gravity. When the hatch 2 is opened, for example by pushing it into the hopper 1, as shown in broken lines in FIG. 1, the side of the hopper is open for the introduction of the waste to be compacted. Under the upper portion 101, the hopper 1 has a further descending portion 201, whose longitudinal axis forms an acute angle A having an appropriate size of about 30-50°, for example about 40°, with the vertical axis of the upper portion 101. As shown in detail in FIG. 2, the wall 301 of the second portion 201 of the hopper is formed by an independent structure which is, for example, attached, in its upper part for example, to suitably positioned areas 3 of the hopper, and which is then fixed, in its lower part at least, to the hopper by means of a screw knob 4 or other suitable means. This wall 301 has lateral hooks 5 in its upper and lower parts, by which it can be suspended securely on supporting cross members or pivots 6 of a removable containing enclosure 19 of the device, which is described more fully below.

The wall 401 of the hopper 1 is substantially parallel to the inclined wall 301 and has, in a central lower position, the inlet opening which is the opening of greater diameter of a compaction and discharge conduit 7 of truncated conical shape, which has a small cross section and limited length, the lower outlet opening of this conduit being shut off by constriction means of any suitable type, comprising for example a small hatch 8 oscillating about a horizontal upper axis 108 and urged towards a closed position by calibrated or calibratable resilient means 208, the whole arrangement being such that the compacted product leaving the conduit 7 tends to be discharged towards the centre of the underlying part of the device in question (see below).

The lower part 201 of the hopper 1 has a lower shape which is at least semi-conical or, as shown in the drawings, is a shape which is semi-cylindrical in the portion near the wall 301 and which extends towards the conduit 7 in a semi-conical form, in such a way that the area 10 of connection between these portions is at the lowest level and any liquid present in the waste to be compacted tends to flow into this area by gravity. As shown in FIG. 1, the inlet opening of the discharge conduit 7 can be surrounded by a small annular projecting bead 11 with a rounded profile, shown in broken lines, which acts as a barrier to prevent the outflow of the liquids from the conduit 7, but which is designed so as not to create a significant obstruction to the flow of the product to be compacted towards the conduit 7. The walls of the lower part 201 of the hopper are provided with small drainage holes 9. A drip strip 12 in the form of an inverted U is welded externally on the wall 401 of the hopper, around the upper and upper middle part of the discharge opening 7, this drip strip accommodating the inner edge 113 of the grooved profile (FIG. 1) of an upper tray 13 which collects the liquid leaving the upper drainage holes 9 and discharges it by gravity into a lower tray 14, which partially overlaps the first tray 13 and collects the liquid leaving the lower parts through the additional drainage holes 9 and through the base 10 of the hopper, and which is provided in its lowest part with an opening with a discharge conduit 114 out of which all the liquid drained through the drainage holes 9 flows (see below). Suitable male and female screw means 213 and 214 are provided for the removable fastening of the trays 13 and 14 to the hopper 1 (FIG. 2).

The inner surfaces of the discharge conduit 7 and of the lower area 201 of the hopper 1 are provided with longitudinal and preferably projecting ribs 15 which promote the flow of the product from the hopper to the discharge conduit 7 with the aid of a transport and compaction helix or spiral 16, of truncated conical shape, made for example from a steel plate, positioned with its axis aligned with that of the conduit 7 and of the lower semi-conical portion 201 of the hopper, converging downwards and with a pitch decreasing progressively downwards, and fixed to the slow output shaft 117 of a reduction gear unit 17, which is fixed to the outer face of the wall 301 of the hopper, and which is driven, by means of any suitable transmission system 217, by an electric motor 317 which is also fixed to the wall 301. The lower end of the spiral 16 enters the compaction and discharge conduit 7, substantially occupying half or more of the length of the conduit. In the example shown in the drawings, the shaft 117 extends axially as far as the inlet opening of the conduit 7, where it terminates in an oblique cut-off shape 117′ by means of which the shaft is welded axially to the final portion of the spiral 16. The upper end of the spiral 16 is provided with a substantially radial arm 116 which is also welded to the shaft 117. However, the scope of the invention also includes a minor constructional variant in which the spiral 16 can be fixed to the shaft 117 by only one of its ends, or by only the lower or the upper end. In the latter case, the shaft 117 can have the minimum length required for its purpose, the advantage of this arrangement being that it does not axially engage in the spiral 16 and the hopper 1 and does not accumulate on itself any string-like waste which may require periodic intervention for its removal. In the case in which the spiral 16 is fixed to the shaft 117 by its upper end only, any mechanical connecting means can be provided, these means being designed to ensure that the dynamic balance of the rotating element is correct.

The reduction gear unit 17 rotates the spiral 16 in the direction indicated by the arrow F at a speed such that the waste, which is thrown in a loose state into the hopper 1 and which flows in a converging way by gravity into the lower part 201 of the hopper where the spiral 16 operates, is picked up by the spiral 16, which, because of its direction of rotation and the ribs 15 of the stator body 1, 7, forcibly drives and impels the waste downwards and subjects it to a high initial degree of compaction as a result of the progressive downward decrease of its pitch and the conical and downwardly decreasing shape of the spiral and the corresponding final lower part of the conduit 7 which, because of its conical shape and small diameter and the presence of the constriction means 8, 108, 208 at its discharge opening, causes the waste to be additionally compacted and maintained in the compacted state in which the waste is subsequently discharged and falls into an underlying container 18, housed in the form of a drawer, for example, or in any other removable way, in the lower part of an enclosure 19 (FIG. 1) in which the device according to the invention is housed and which also houses removably in a lower position a small tank 20 for collecting the liquids leaving the conduit 114. The enclosure 19 can be provided with wheels, and contains the fixed cross members or pivots 6 for supporting the device. The upper wall 119 of the enclosure, covering the hopper 1, can be made wholly or partially of transparent material and/or can be made removable to facilitate the routine and emergency maintenance of the device. The part 219 of the enclosure lying above the reduction gear drive unit 17, 217, 317 can also be made removable and can advantageously be provided with ventilation slits to dissipate the heat generated by the electric motor 317, in a way which will be evident to persons skilled in the art.

Suitable safety means are to be provided to reverse the rotation of the motor 317 automatically if the motor is subjected to overload, or to stop it if such overloads are repeated and persistent. Suitable safety means are also to be provided to stop the motor 317 automatically when the hatch 2 is open and to indicate to the user the periodic need to empty the bag or container 18 or the tank 20. Clearly, the liquids can alternatively be disposed of directly into the sewers where this is possible.

1. Waste compactor, of simplified construction and of small dimensions, particularly for bars, cafeterias or other small restaurant businesses, characterized in that it comprises at least one robust transport screw, helix or spiral (16), inclined in such a way that its axis forms an acute angle of appropriate size with an incident vertical axis, the transport spiral (16) having a downwardly converging conical shape and a downwardly decreasing pitch, and being aligned axially with and fixed to the slow shaft (117) of a reduction gear unit (17) located above and driven through any suitable means (217) by a suitable motor (317), these drive means being positioned outside the inclined wall (301) of a loading hopper (1) which has an upper descending portion (101) with at least one hatch (2) for the introduction of the waste to be compacted into the hopper which extends downwards with an inclined portion (201) in which the transport spiral (16) operates transversely, the terminal portion of the spiral, which has a smaller diameter, rotating in a conical outwardly converging compaction and discharge conduit (7) whose outlet opening is shut off by constriction means (8, 108, 208), the lower part (201) of the hopper being characterized by a funnel shape which is wholly or partially open upwards and which acts as the stator of the transport spiral (16), this lower part being provided with drainage holes (9) and a base area (10) into which any liquid present in the waste tends to flow by gravity, means (13, 14, 114) being provided to collect the liquid flowing out of the drainage holes and to guide it by gravity towards discharge means (20) positioned under the device, together with a container (18) which is also removable and which collects the waste which, by the action of the transport spiral (16) and guide ribs (15) present in the lower part of the hopper (1) and in the discharge conduit (7), is compacted and discharged from the conduit (7) with the corresponding constriction means (8, 108, 208).

2. Compactor according to claim 1, in which the drive unit (17, 217, 317) is fixed to a wall (301) of the hopper (1) which is fixed removably to the other parts of the hopper, for example by means of fastening elements (3) and screws (4).

3. Compactor according to claim 2, in which the movable wall (301) of the hopper (1) is provided in distributed locations with means (5), in the form of hooks for example, by which they can be suspended removably on pivots or cross members (6) fixed to the walls of any suitable enclosure (19, 119, 219) which removably contains the compactor in question.

4. Compactor according to claim 1, in which the transport spiral (16) is fixed by portions at both of its ends to an extension of the axial drive and support shaft (117) having a distal end in the form of an oblique cut-off (117′) which preferably does not enter the final compaction and discharge conduit (7).

5. Compactor according to claim 1, in which the transport spiral (16) is fixed by its upper end only to the drive and support shaft (117), by suitable connecting means which if necessary can also provide static and dynamic balancing of the rotating element, in which case the shaft (117) does not axially engage in the transport spiral (16).

6. Compactor according to claim 1, in which the longitudinal axis of the lower part (201) of the hopper, in which the transport spiral (16) operates, forms an acute angle (A) in the range from 30° to 50°, for example about 40°, with the vertical axis of the upper part (101) of the hopper (1).

7. Compactor according to claim 1, in which the lower part (201) forms a substantially conical shape which can be wholly or partially open towards the upper part (101) of the hopper, which has an end of smaller diameter communicating with the conical compaction and discharge conduit (7), and which is connected to the movable wall (301) with the means of rotation of the transport spiral (16) by a semi-cylindrical portion, the whole arrangement being such that, in the area of connection between these conical or semi-conical and semi-cylindrical parts, there is a base area (10) in which any liquid present in the waste to be compacted tends to accumulate by gravity.

8. Compactor according to claim 1, characterized in that it can comprise a projecting bead with a rounded profile (11) at the inlet opening of the compaction and discharge conduit (7), in order to divert the liquid to be drained towards the underlying surfaces by means of the base area (10).

9. Compactor according to claim 1, in which a drip strip (12) in the form of an inverted U is welded externally around the upper and upper middle part of the compaction and discharge conduit (7), this drip strip accommodating the inner edge (113) of the grooved profile of an upper tray (13) which collects the liquid leaving the upper drainage holes (9) and discharges it by gravity into a lower tray (14), which partially overlaps the first tray (13) and collects the liquid leaving the lower parts through the additional drainage holes (9) and through the base area (10) of the hopper (1), and which is provided in its lowest part with an opening with a discharge conduit (114) out of which all the liquid drained through the drainage holes (9) flows.
